(19) United States
(12) Patent Application Publication
(10) Pub. No.: US 2014/0152941 A1
(43) Pub. Date: Jun. 5, 2014

(54) BACKLIGHT MODULE AND LCD DEVICE

(71) Applicant: SHENZHEN CHINA STAR OPTOELECTRONICS TECHNOLOGY CO., LTD., Shenzhen (CN)

(72) Inventors: Shihhsiang Chen, Shenzhen (CN); Ruilian Yang, Shenzhen (CN)

(21) Appl. No.: 13/701,830

(22) PCT Filed: Oct. 25, 2012
(86) PCT No.: PCT/CN2012/083508

§ 371 Date: Dec. 4, 2012

(30) Foreign Application Priority Data
Sep. 29, 2012 (CN) 201220514765.3

(51) Int. Cl. F21V 8/00

(52) U.S. Cl. CPC G02B 6/0088
USPC 349/65; 362/611

(57) ABSTRACT

The present disclosure provides a backlight module and a liquid crystal display (LCD) device, including: a backplane, a light guide panel (LGP) arranged in the backplane, a light source arranged on a side of the backlight module and opposite to the light incident surface of the LGP, and a limit frame arranged at an edge of the LGP to limit movement of the LGP. The limit frame is made of sheet metal, the limit frame is configured with a limit structure and a fixing structure connected to the limit structure, the limit frame is fixed to the backplane by the fixing structure, and the limit structure butts and presses on an edge of the light emitting surface of the LGP.

### FIELD

The present disclosure relates to the field of liquid crystal displays (LCDs), and more particularly to a backlight module and an LCD device.

### BACKGROUND

Liquid crystal displays (LCDs) that are light weight, have a thin profile, have a low power consumption, are some qualities welcomed by consumers. However, with the development of LCD technology, LCDs with narrower frames are main driving force in the market.

As shown in FIG. 1, a backlight module of an LCD device includes a frame 10, light guide panel (LGP) 20, an optical film 21 arranged on the LGP 20, a backplane 30, and a light source 40. The LGP 20 and the optical film 21 on the LGP 20 are both arranged above the backplane 30. The frame 10 presses a light emitting surface of the LGP 20 to enable the LGP 20 to be fixed in the backplane 30, and the frame 10 butts and presses on an edge of the light emitting surface of the LGP 20 by a limit structure 11 of the frame 10. With the development of design of narrower frames, width of the limit structure 11 becomes narrower, namely a size of the frame 10 pressed on the LGP 20 becomes smaller. Moreover, poor rigidity of the frame 10 itself, when the LGP 20 deforms, the housing 10 may not press against the LGP 20 by the limit structure 11, so that the LGP 20 significantly deforms or moves which may make the display quality of the LCD device be reduced or even break the LCD panel.

### SUMMARY

In view of the above-described problems, the aim of the present disclosure is to provide a backlight module and a liquid crystal display (LCD) device with reliably fixed light guide panel (LGP).

The aim of the back light module of the present disclosure is achieved by the following technical scheme. A backlight module, comprising:

a backplane;

a light guide panel arranged in the backplane;

a light source arranged on a side of the backlight module and opposite to the light incident surface of the LGP; and

a limit frame arranged at an edge of the LIP The limit frame limns movement of the LGP and is made of sheet metal. The limit frame is configured with a limit structure and a fixing structure connected to the limit structure, the limit frame is fixed to the backplane by the fixing structure, and the limit structure butts and presses on an edge of a light emitting surface of the LGP.

The light source is arranged on the limit structure, and the sidewall of the backplane is configured with a cutout that receives the light source.

A nub and a notch engaged with the nub are arranged between the fixing structure of the limit frame and the sidewall of the backplane, and the limit frame is fixed to the backplane by the nub engaging with the notch.

The aim of the present disclosure is further achieved by the following technical scheme. A backlight module comprises a backplane, a light guide panel (LGP) arranged in the backplane, a light source arranged on a side of the backlight module and opposite to the light incident surface of the LGP, and a limit frame arranged at an edge of the LGP and limits movement of the LGP and is made of sheet metal. The limit frame is configured with a limit structure and a fixing structure connected to the limit structure, the limit frame is fixed to the backplane by the fixing structure, and the limit structure butts and presses on an edge of a light emitting surface of the LGP.

In one example, the light source is arranged on the limit frame, and the sidewall of the backplane is configured with a cutout that receives the light source. Thus, a distance from a light emitting surface of the LGP to a light emitting surface of the light source can be increased, and display effect can be increased. Alternatively, width of the LGP can be increased at the same time, which facilities display brightness of the edge of the LCD device in the design of narrower frames.

In one example, a nub and a notch engaged with the nubare arranged between the fixing structure of the limit frame and the sidewall of the backplane, and the limit frame is fixed to each other the backplane by the nub and the notch engaged with the nub, which facilitates assembling between the limit frame and the backplane, and increases assembling efficiency of the backlight module.

In one example, the notch is arranged on the fixing structure of the limit frame, and the nub is arranged on the sidewall of the backplane.

In one example, the notch is arranged on the sidewall of the backplane, and the nub is arranged on the fixing structure of the limit frame.

In one example, the middle frame is fixed to the backplane by screws. The screw fixing mode is more reliable.

In one example, the backplane is configured with a protrusion that supports the light guide panel (LGP) to reduce heat generated by the light source which ma be transferred to the LGP.

In one example, the sheet metal is made of copper alloy. Copper alloy has preferable heat dissipation effect.

In one example, the sheet metal is made of aluminum alloy. Aluminum alloy is relatively cheap and has preferable heat dissipation effect.

An LCD device comprises the backlight module mentioned above.

The main aim of the present disclosure is to provide a limit frame made of sheet metal to limit movement of the LCP of the backlight module. Because the sheet metal has the characteristic of higher rigidity, which increases limit reliability to the LGP. In design of narrower frames, because the limit frame made of sheet metal has a higher rigidity, width of the limit structure of the limit frame can be made smaller relative to width of the limit structure of typical frame, and then frame width of the LCD device can be reduced. Because the limit frame with the higher rigidity can still limit and fix the LGP when the width of the limit structure is reduced, which avoids large displacement of the LGP when the LGP deforms, reduces display quality of the LCD device, and effectively protects the LCD panel.

### BRIEF DESCRIPTION OF FIGURES

FIG. 1 is a simplified structural diagram of a typical backlight module; and

FIG. 2 is a simplified structural diagram of a backlight module of an example of the present disclosure.

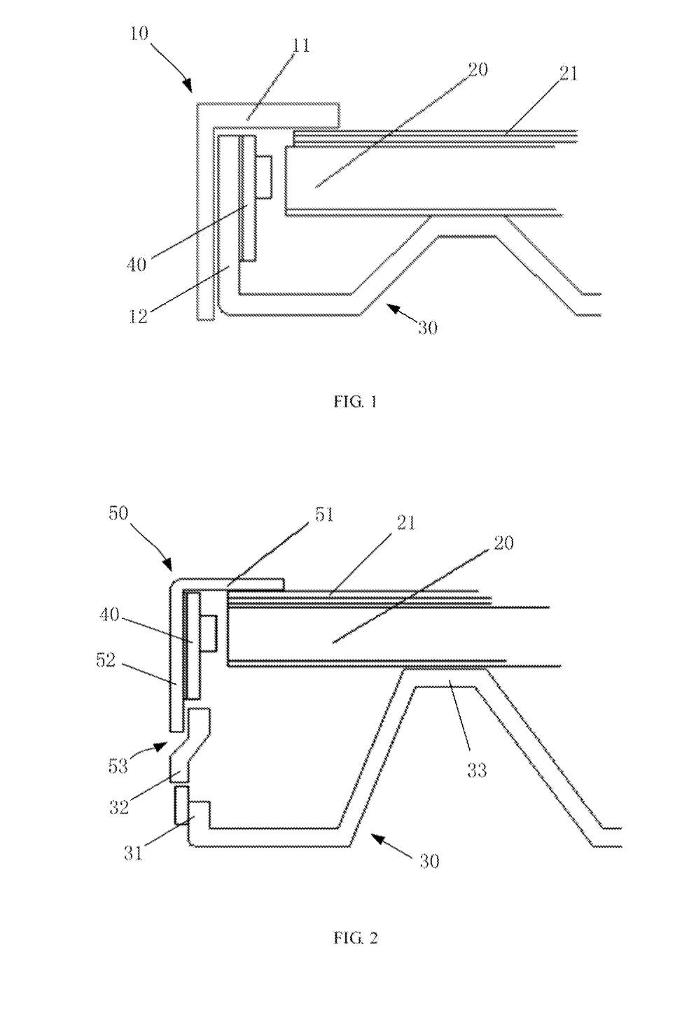

Legends: 10. frame; 20. light guide panel (LGP); 30. backplane; 40. light source; 11. limit structure; 31. sidewall of backplane; 32, nub; 33. protrusion; 50. limit frame; 51. limit structure; 52, fixing structure; 53. notch.

### DETAILED DESCRIPTION

The present disclosure will further be described in detail in accordance with the figures and the examples.

As shown in FIG. 2, a backlight module of a liquid crystal display (LCD) device comprises a limit frame 50, a light guide panel (LGP) 20, an optical film 21 arranged on the LGP 20, a backplane 30, and a light source 40. The LGP 20 and the optical film 21 on the LGP 20 are both arranged above the backplane 30. The limit frame 50 press (fixed position) an edge of a light emitting surface of the LGP 20 to enable the LGP 20 to be fixed in the backplane 30. The limit frame 50 is made of sheet metal, the limit frame 50 is configured with a limit structure 51 and a fixing structure 52 connected to and relatively perpendicular to the limit structure 51, the limit frame 50 is fixed to the backplane 30 by the fixing structure 52, and the limit structure 51 butts and presses on the edge of the light emitting surface of the LGP 20. A main aim of the present disclosure is to provide a limit frame 50 made of sheet metal to limit movement of the LGP 20 of the backlight module. The sheet metal has the characteristic of higher rigidity, which increases limit reliability to the LGP 20. In design of narrower frames, because the limit frame 50 made of the sheet metal has a higher rigidity, width of the limit structure 51 of the limit frame can be made smaller relative to width of the limit structure of typical frame, and then frame width of the LCD device can be reduced. Because the limit frame with the higher rigidity can still limit and fix the LGP when the width of the limit structure is reduced, which avoids large displacement of the LGP when the LGP deforms, reduces display quality of the LCD device, and effectively protects the LCD panel.

A nub 32 and a notch 53 engaged with the nub 32 are arranged between the limit frame 50 and the backplane 30. The limit frame SO is fixed to the backplane 30 by the nub 32 engaging with the notch 53. The notch 53 is arranged on the limit frame 50, and the nub 32 is arranged on a sidewall 31 of the backplane 30. When assembling, the limit frame 50 is pressed downward to enable the notch 53 be engaged with the nub 32 so that the limit frame 50 is fixed to the backplane 30. Alternatively, the notch can be arranged on the backplane, and the nub can be arranged on the limit frame. By such arrangement, assembling efficiency of the backlight module is increased. Optionally, the limit frame 50 can be fixed to the backplane 30 by screws as well However, fixing with screws is more reliable.

The light source 40 is directly arranged on the limit frame 50. The sidewall 31 of the backplane 30 is configured with a cutout (not shown in the figures) that receives the light source 40. The cutout can receive the light source 40 so that the light source 40 is aligned with the light incident surface of the LGP 20. Because the light source 40 is arranged on the limit frame 50 rather than on the backplane 30, the light source 40 is moved from an inside of the backlight module to an outside of the backlight module, which increases a distance from a light emitting surface of the LGP 20 to a light emitting surface of the light source 40 to avoid Firefly Phenomenon. Alternately, width of the LGP 20 can be increased to enable an edge of the LGP 20 to be closer to an outmost edge of the backlight module, which facilities design of narrower frames, and ensures display brightness of the edge of the LCD panel in the design of narrower frames.

To reduce influence caused by heat generated by the light source 40 transferring to the LGP 20 via the backplane 30, the backplane 30 is configured with a protrusion 33 that supports the LGP 20. Meanwhile, to increase heat dissipation efficiency, the sheet metal material used by the limit frame 50 of the example has better heat conductivity, such as copper alloy or aluminum alloy, which is beneficial to dissipate heat generated by the light source 40 in time and protect inside components of the backlight module.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

1. A backlight module, comprising:
a backplane;
a light guide panel (LGP) arranged in the backplane;
a light source arranged on a side of the backlight module and opposite to the light incident surface of the LGP; and
a limit frame arranged at an edge of the LGP;
wherein the limit frame limits movement of the LGP and is made of sheet metal, the limit frame is configured with a limit structure, and a fixing structure connected to the limit structure, the limit frame is fixed to the backplane by the fixing structure, and the limit structure butts and presses on an edge of a light emitting surface of the LGP; and
wherein the light source is arranged on the limit structure, and a sidewall of the backplane is configured with a cutout that receives the light source; and
wherein a nub and a notch engaged with the nub are arranged between the fixing structure of the limit frame and the sidewall of the backplane, and the limit frame is fixed to the backplane by the nub engaging with the notch.

2. A backlight module, comprising:
a backplane;
a light guide panel (LGP) arranged in the backplane;
a light source arranged on a side of the backlight module and opposite to the light incident surface of the LGP; and
a limit frame arranged on an edge of the LGP;
wherein the limit frame limits movement of the LGP and is made of sheet metal, the limit frame is configured with a limit structure and a fixing structure connected to the limit structure, the limit frame is fixed to the backplane by the fixing structure, and the limit structure is butted and pressed on an edge of a light emitting surface of the LGP.

3. The backlight module of claim 2, wherein the light source is arranged on the limit structure, and a sidewall of the backplane is configured with a cutout that receives the light source.

4. The backlight module of claim 2, wherein a nub and a notch engaged with the nub are arranged between the fixing structure of the limit frame and a sidewall of the backplane, and the limit frame is fixed to each other the backplane by the nub engaging with the notch.

5. The backlight module of claim 4, wherein the notch is arranged on the fixing structure of the limit frame, and the nub is arranged on the sidewall of the backplane.

6. The backlight module of claim 4, wherein the notch is arranged on the sidewall of the backplane, and the nub is arranged on the fixing structure of the limit frame.

7. The backlight module of claim 2, wherein the limit frame is fixed to the backplane by screws.

8. The backlight module of claim 2, wherein the backplane is configured with a protrusion that supports the light guide panel (LGP).

9. The backlight module of claim 2, wherein the sheet metal is made of copper alloy.

10. The backlight module of claim 2, wherein the sheet metal is made of aluminum alloy.

11. A liquid crystal display (LCD) device, comprising:
backplane;
a light guide panel (LGP) arranged in the backplane;
a light source arranged on a side of the backlight module and opposite to the light incident surface of the LGP; and
a limit frame arranged at an edge of the LGP;
wherein the limit frame limits movement of the LGP and is made of sheet metal, the limit frame is configured with a limit structure and a fixing structure connected to the limit structure, the limit frame is fixed to the backplane by the fixing structure, and the limit structure is butted and pressed on an edge of a light emitting surface of the LGP.

12. The liquid crystal display (LCD) device of claim 11, wherein the light source is arranged on the limit frame, and the sidewall of the backplane is configured with a cutout that receives the light source.

13. The liquid crystal display (LCD) device of claim 11, wherein a nub and a notch engaged with the nub are arranged between the fixing structure of the limit frame and a sidewall of the backplane, and the limit frame is fixed to the backplane by the nub engaging with the notch.

14. The liquid, crystal display (LCD) device of claim 13, wherein the notch is arranged on the fixing structure of the limit spacing, and the nub is arranged on the sidewall of the backplane.

15. The liquid crystal display (LCD) device of claim 13, wherein the notch is arranged on the sidewall of the backplane, and the nub is arranged on the fixing structure of the limit frame.

16. The liquid crystal display (LCD) device of claim 11, wherein the limit frame is fixed to the backplane by screws,

17. The liquid crystal display (LCD) device of claim 11, wherein the backplane is configured with a protrusion that supports the light guide panel (LGP).

18. The liquid crystal display (LCD) device of claim 11, wherein the sheet metal component is made of copper alloy.

19. The liquid crystal display (LCD) device of claim 11, wherein the slice metal component is made of aluminum alley.
